(19) United States
(12) Patent Application Publication
(10) Pub. No.: US 2018/0012240 A1
(43) Pub. Date: Jan. 11, 2018

(54) SYSTEM AND METHOD OF COMMUNICATING INFORMATIONAL MESSAGES AND MONITORING RECEIPT AND USE OF MESSAGES

(71) Applicant: IRIO Inc., Dallas, TX (US)

(72) Inventor: Russell Davis, Plano, TX (US)

(21) Appl. No.: 15/642,962

(22) Filed: Jul. 6, 2017

Related U.S. Application Data
(60) Provisional application No. 62/359,088, filed on Jul. 6, 2016.

(51) Int. Cl. G06Q 30/02; H04M 1/725; H04L 12/58

(52) U.S. Cl. CPC G06Q 30/0201; H04L 51/046; H04M 1/72552

(57) ABSTRACT

The present disclosure relates to management of informational message communications including distribution and interaction with various types of messages including various types of data and interactive options. Data and tracking gathered with this method can provide innovative methods for businesses to evaluate consumer responsiveness as well as overall effectiveness of certain types of messages.

### RELATED APPLICATION

This application claims priority to U.S. Provisional Patent Application No. 62/359,088, filed Jul. 6, 2016 and entitled “SYSTEM AND METHOD OF COMMUNICATING INFORMATIONAL MESSAGES AND MONITORING RECEIPT AND USE OF MESSAGES,” which is hereby incorporated by reference for all purposes as if set forth herein in its entirety.

### TECHNICAL FIELD

The present disclosure relates generally to an information message communication system, and more specifically to a message communication system and method of use that provides businesses with information and feedback regarding consumer receipt, interaction with, and use of the various messages.

### BACKGROUND OF THE INVENTION

Informational messaging systems are used by businesses to distribute information to consumers who want to receive information without directly talking to an individual employee. However, businesses need additional feedback regarding whether their messages are being delivered, read, and interacted with in order to maximize efficiency of messages.

### SUMMARY OF THE INVENTION

The present disclosure relates to management of informational message communications including distribution and interaction with various types of messages including various types of data and interactive options. Data and tracking gathered with this method can provide innovative methods for businesses to evaluate consumer responsiveness as well as overall effectiveness of certain types of messages.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIGS. 1-4 are diagrams of various user interfaces in accordance with an exemplary embodiment of the present disclosure;

FIGS. 5-6 are diagrams of various recipient database interfaces in accordance with an exemplary embodiment of the present disclosure; and

FIG. 7 is a diagram of an algorithm 100 for management of informational message communications in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

The present disclosure provides a process and system of business intelligence for companies and improved interactivity for consumers using informational messaging services. Any business can use this system to provide pertinent information to their target audience.

In one exemplary embodiment of the present disclosure, the system could be used to allow event participants to text in a keyword and find out information about the event including but not limited to concession locations, merchandise locations, emergency information, contact information, or schedule events.

In another exemplary embodiment of the present disclosure, the system could be used to allow political constituents to text in a keyword and find out information about a politician including but not limited to history, platform, beliefs, news, contact, volunteer and even make donations.

In another exemplary embodiment of the present disclosure, the system could be used to allow grocery shoppers to text in a keyword and find out information about the grocery store including but not limited to events, new products, food locations, contact information, recipes, prices, and more.

In another exemplary embodiment of the present disclosure, the system could be used to allow users to text in a keyword and find out information about a non-profit organization including but not limited to contact information, history, causes, leadership, events and even make a donation.

In another exemplary embodiment of the present disclosure, the system could be used to allow mall or shopping center consumers to text in a keyword and find out information about the location including but not limited to stores, food court, restrooms, events, promotions and more.

In one exemplary embodiment of the present disclosure, the system could be used to allow apartment residents or potential residents to text in a keyword and find out information such as bedroom options, specials, request an appointment, contact information, link to a website and subscribe for updates.

In one exemplary embodiment of the present disclosure, users can subscribe to the system to receive any future updates or arrange certain settings to receive only certain select messages and/or updates.

The present disclosure takes the following innovative approach:

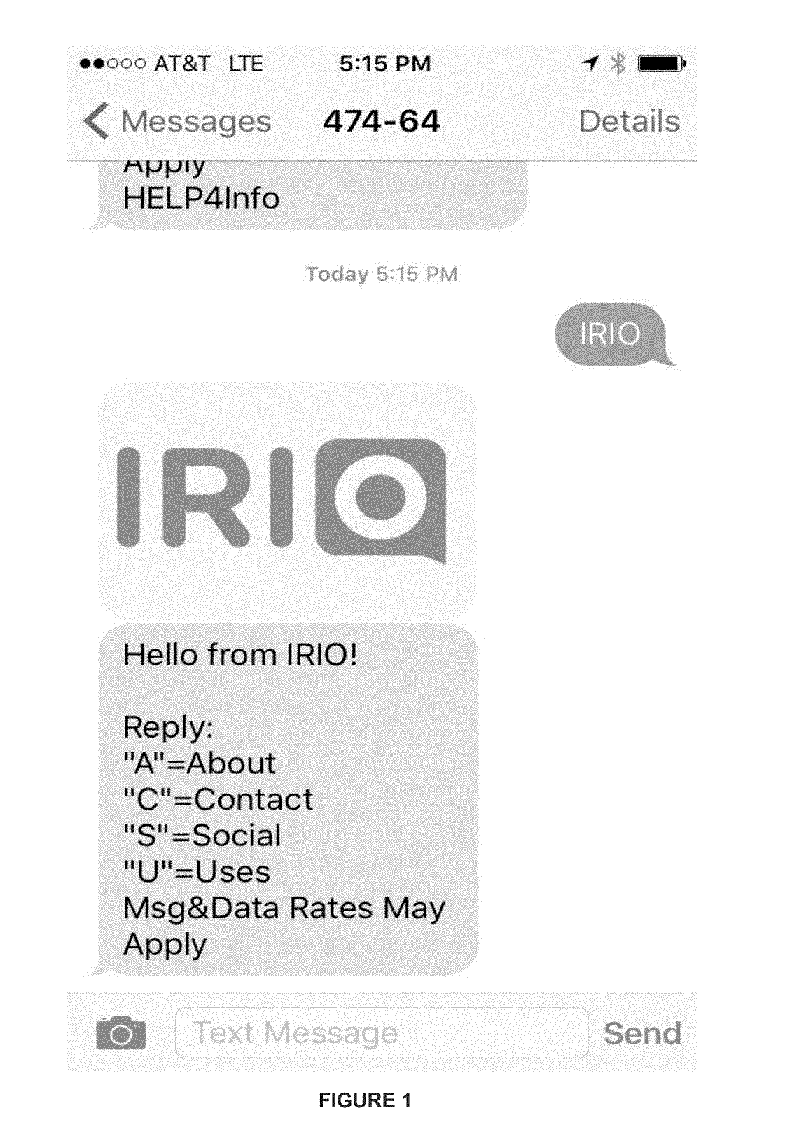

FIG. 1 illustrates an exemplary embodiment of an interactive screen for the present disclosure. In one exemplary embodiment, users are able to enter and transmit certain alphanumeric character codes into a user-based interface and transmit the codes to a recipient. Upon receipt, the recipient can then transmit one or more information messages to the user.

FIG. 1 is an exemplary embodiment of one such type of communication.

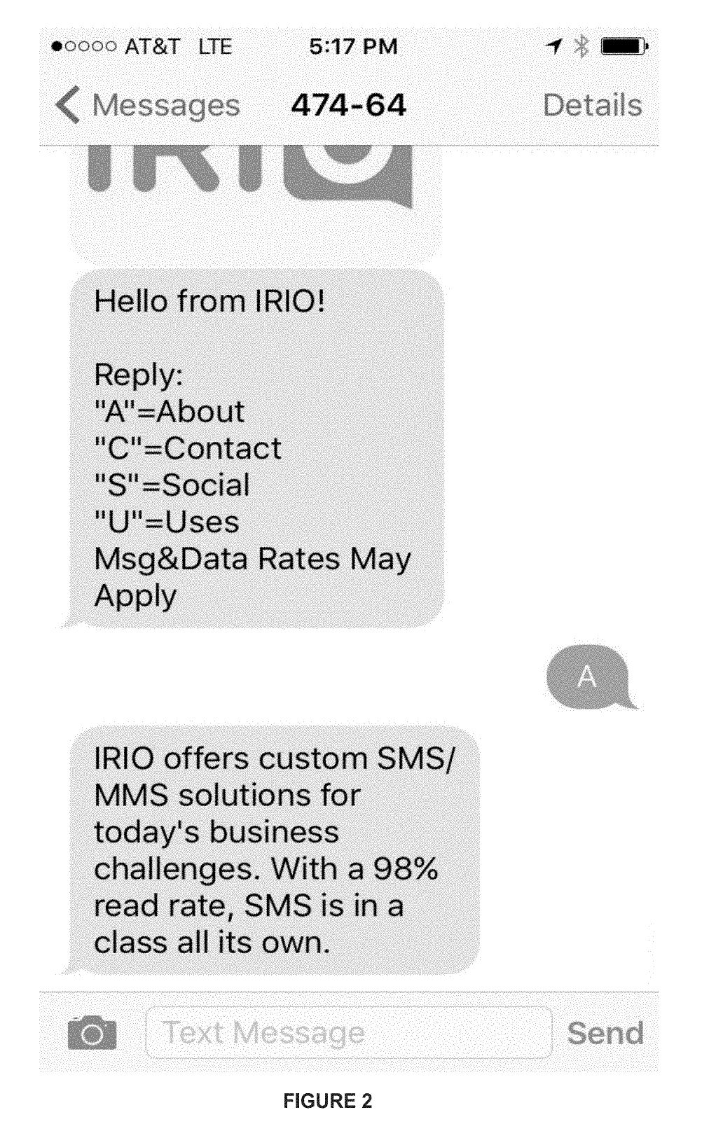

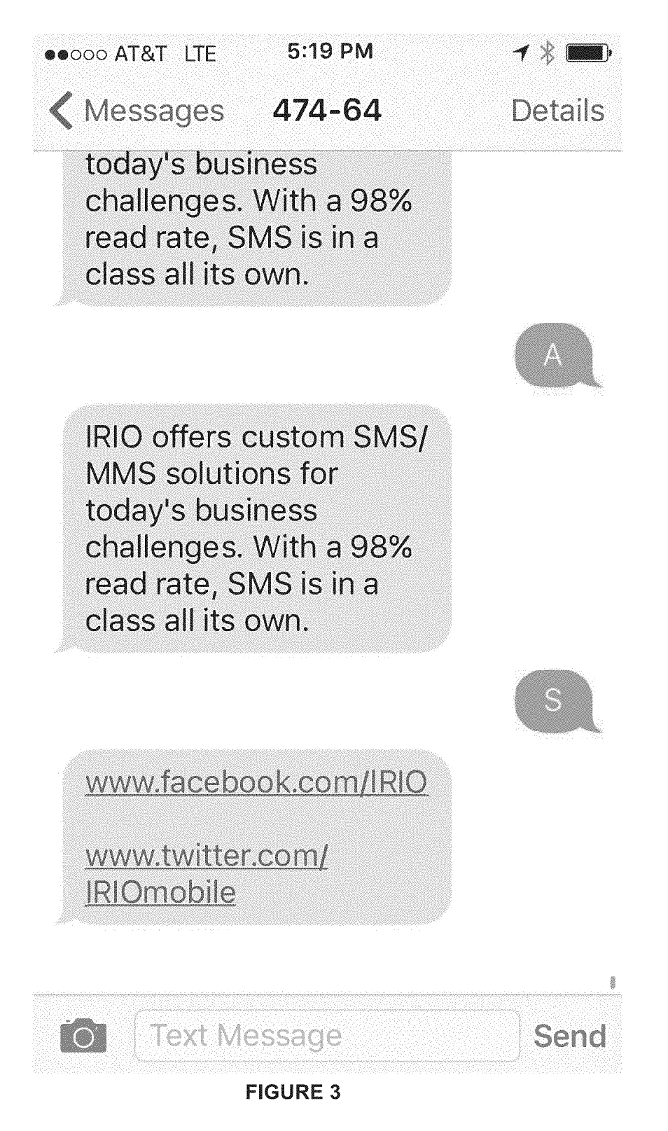

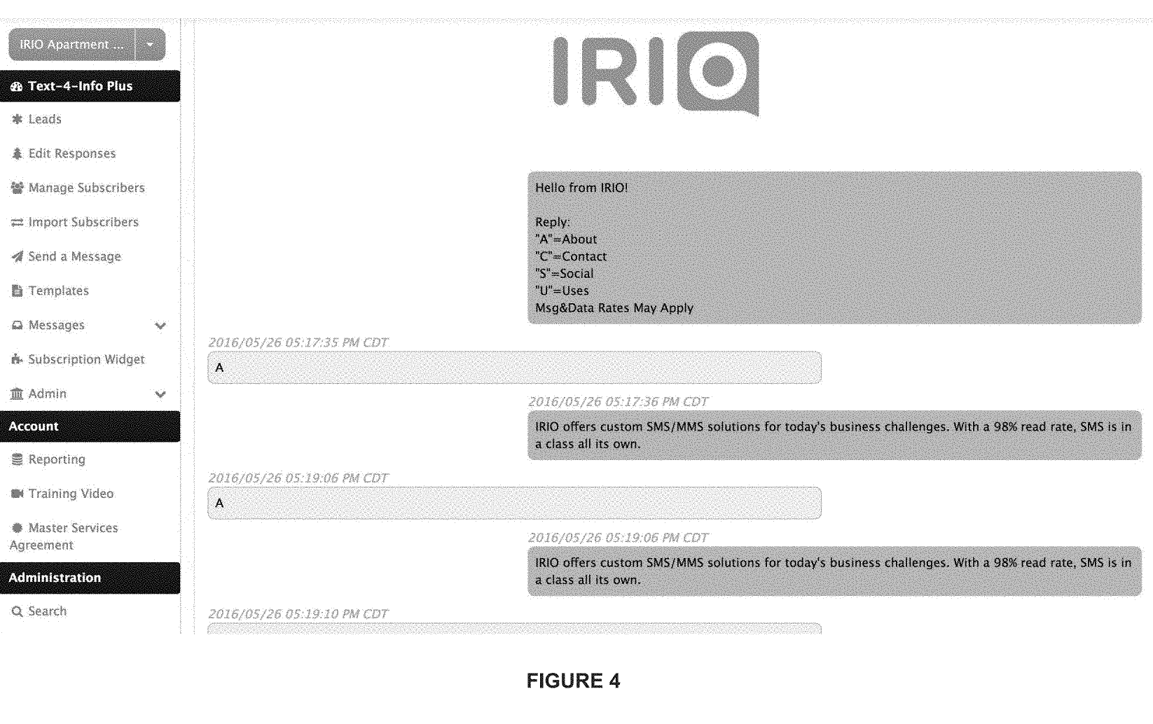

FIGS. 2-4 illustrate an exemplary embodiment of an interactive screen for the present disclosure. In one exemplary embodiment, users are able to select certain alphanumeric codes or short-cuts corresponding to certain action items. Users are able to review and select corresponding action items and transmit the corresponding codes to the recipient. Upon receipt, the recipient then communicates informational messages to the user based on the type of communicated request. Users are able to continuously select various codes corresponding with individual requests as desired. For example, users may select “A” to receipt information about the underlying service. As another exemplary embodiment, users may select “C,” “S,” “U,” or “V” to receive informational messages regarding “Contact,” “Social,” “Uses,” or “Video” via the user-interface.

In one exemplary embodiment of the present disclosures, users are individual consumers interacting with the informational messaging system using computing devices including but not limited to computers, desktop computers, laptop computers, hand-held devices, embedded devices, and the like.

In one exemplary embodiment of the present disclosures, recipients are businesses interacting with the informational messaging system using computing devices including but not limited to computers, desktop computers, laptop computers, hand-held devices, embedded devices, and the like.

In one exemplary embodiment of the present disclosures, recipients are third-party informational services interacting with the informational messaging system using computing devices including but not limited to computers, desktop computers, laptop computers, hand-held devices, embedded devices, and the like.

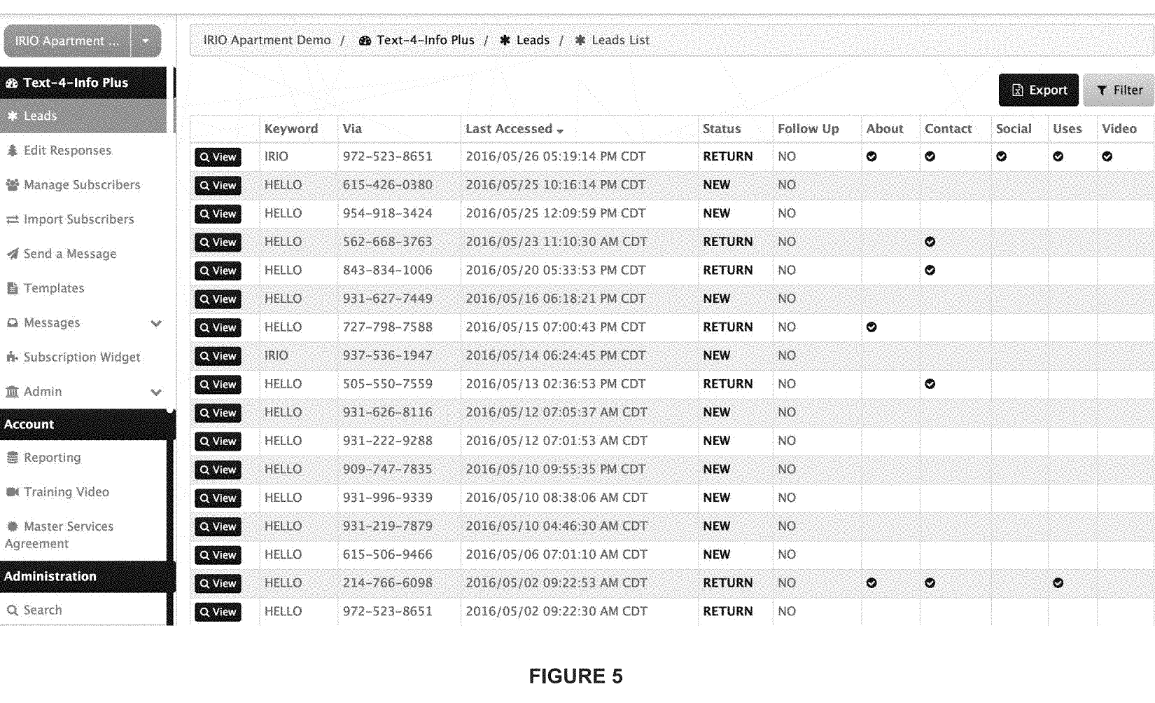

FIG. 5 illustrates an interactive information system in accordance with one exemplary embodiment of the present disclosure. In one exemplary embodiment of the present disclosure, the information system tracks communications to and from users and recipients and maintains a log of all such communications. FIG. 5 depicts one exemplary embodiment of such a log. As depicted in FIG. 5, the log can contain information about the user's contact information, time stamps for messages and interactions, message statuses, interactive statuses such as follow-ups, and information regarding user-requested information such as those described above.

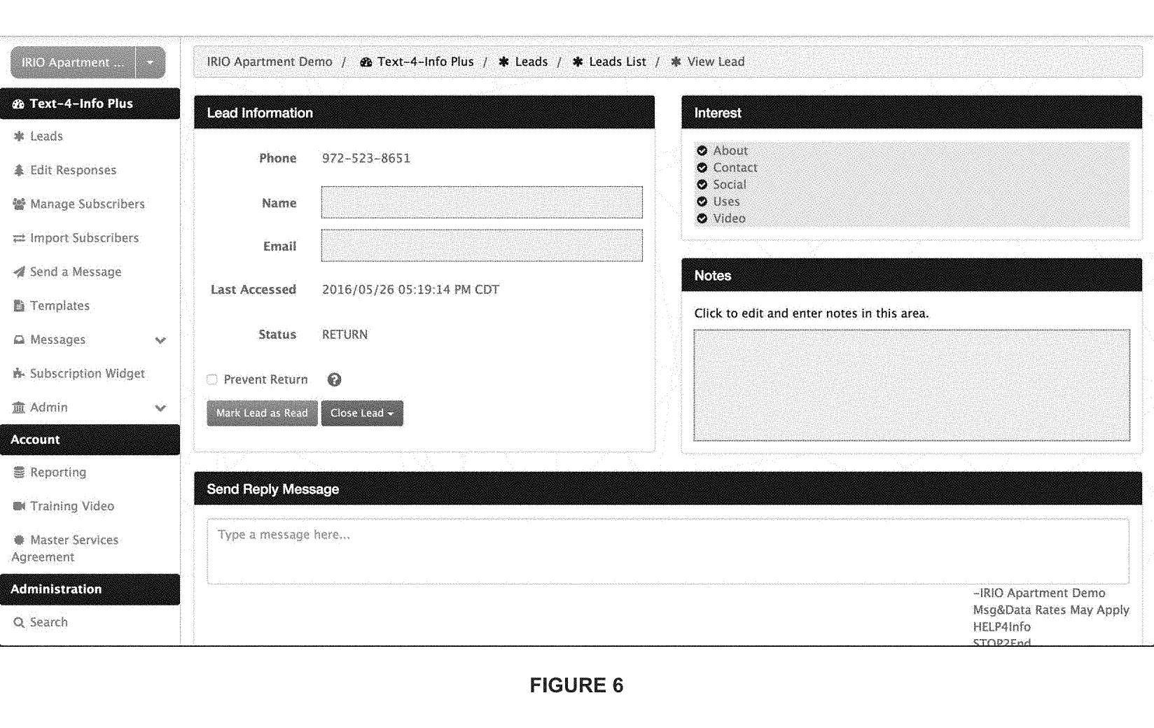

FIG. 6 illustrates an interactive information system in accordance with one exemplary embodiment of the present disclosure. As depicted in FIG. 5, in one exemplary embodiment of the present disclosure, the information system tracks communications to and from users and recipients and maintains a log of all such communications. In one exemplary embodiment of the present disclosure, the system also allows recipients to access individual records for individual users or recipients. FIG. 6 depicts one exemplary embodiment of such an individual log. As depicted in FIG. 6, the log can contain information about the user's contact information, time stamps for messages and interactions, message statuses, interactive statuses such as follow-ups, and information regarding user-requested information such as those described above. The log can also include specific interactive information such as “Name,” “Email,” “Notes,” and “Messages.”

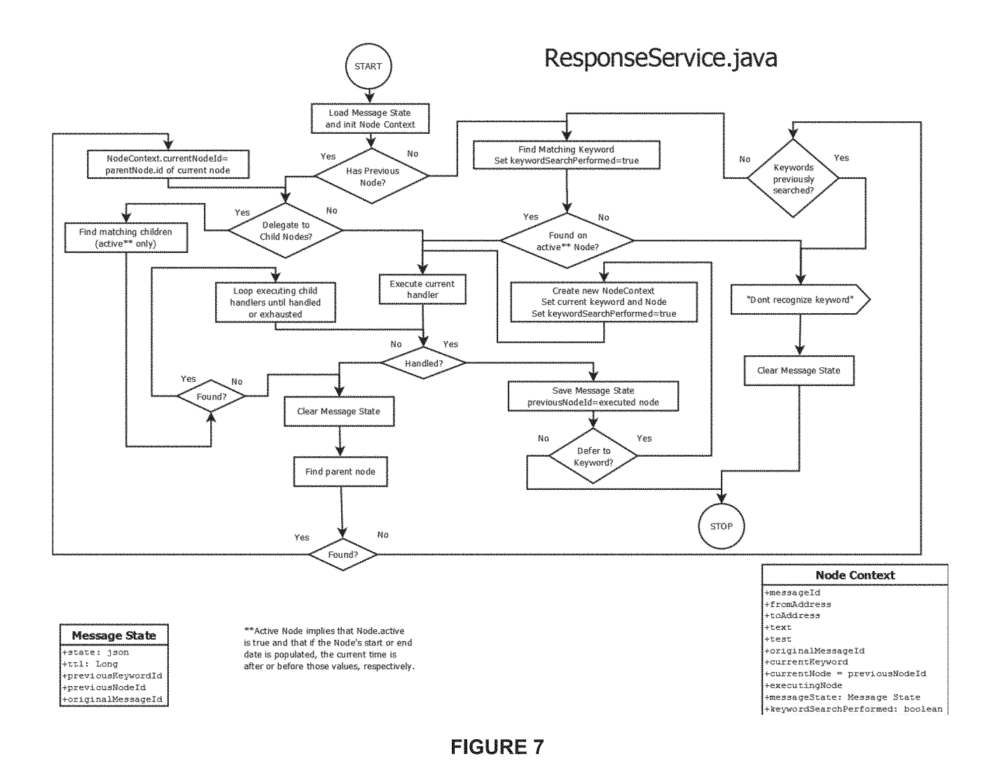

FIG. 7 is a diagram of an algorithm for analyzing and communicating information messages in accordance with an exemplary embodiment of the present disclosure. Algorithm 100 is implemented in hardware or a suitable combination of hardware and software, and can be one or more software systems operating on one or more processors.

The terms used in algorithm 100 are further described as:

“Address” shall mean the focus or recipient of communications including, but not limited to, user operated computers, handheld devices, and other networked devices.

“Message State” shall include: a reference to the original message which began the current conversation with Address; a keyword that began the conversation, if any; a TTL (“time to live”) before erasing the Message State; the most recently accessed Node; any state specific to the most recently accessed Node that may be helpful in subsequent communications.

“Load Message State and init Node Context” shall mean the step of referencing the Message State and initializing Node Context which contains ephemeral data while processing the current message.

“Has Previous Node?” shall mean the step of determining whether there a previous message for which the Message State has not yet been erased.

“Find Matching Keyword” shall mean that once it is determined that there is no Message State, the step of comparing the inbound message to system Keywords, looking for the best match.

“Found on active Node?” shall mean the step of searching only for active Keywords on active Nodes.

“Don't recognize keyword” shall mean the step of responding to the inbound message that the system was unable to find a matching Node to take any action.

“Clear Message State” shall mean the step of marking the current conversation for the Address as ended & deleting the Message State for the “current” conversation. The Node Context shall not be deleted until “STOP” is reached.

“Execute current handler” shall mean the step of executing a handler within a particular Node. Each Node has a handler. The handler will indicate whether or not it was able to handle the request and the new Message State TTL.

“Handled?” shall mean the step of determining whether a handler was able to accommodate an incoming message. Some handlers may not be able to handle the incoming message even if the handler is determined to be a match. If the handler is not able to handle the request, the Node Context will be updated to point to the parent Node, and the system will attempt to process the request from the parent Node. However, the parent Node may still delegate the processing to a children Node. If there is no parent Node and no Keyword search was previously made on this request, an attempt is made to match a Node by Keyword.

“Save Message State” shall mean the step of saving data about the current conversation for future inbound messages within a TTL window.

“Defer to Keyword?”—Some handlers may want to give the option to give a keyword match priority over the handler. If this is the case, the conversation is redirected to the Node matching the Keyword, where the request will be handled.

“NodeContext.currentNodeId=parentNode.id of current node” shall mean the step of updating the ephemeral data for the inbound message request to point to the parent Node.

“Find parent node” shall mean the step of sending responsibility to its parent when a Node says it did not handle the request.

“Delegate to Child Nodes” shall mean that if a Node is initialized, the handler type determines if the Node is allowed to delegate a response to an inbound message to its children.

“Find matching children” shall mean that the match string and match mode of each active child Node is evaluated for a match. If a child is a match, but it is unable to handle the request, subsequent children are given the opportunity to handle the request before sending the request to the parent, if any.

As used herein, “hardware” includes a combination of discrete components, an integrated circuit, an application-specific integrated circuit, a field programmable gate array, or other suitable hardware. As used herein, “software” includes one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

What is claimed is:

1. A system for delivering and monitoring informational message communications, comprising:
a communication management system operating on a processor and configured to receive requests for business information data from a requesting party and communicate said requests to a business information database system; and
a business information database system operating on a processor and configured to receive and store business information data;
wherein the communication management system is configured to receive business information data from the business information database system in response to requests for data from the requesting party and also configured to provide real-time business information data to said requesting party.

2. The system of claim 1 wherein the business information data comprises one or more of business hours, business contact information, business services, business goods, business promotions and any other conventional business information for suitable purposes.

3. A method for delivering and monitoring information message communications, comprising:
receiving at least one request for information from a user;
determining the type of requested information based on the request type;
accessing a business information database to retrieve the requested information;
providing the requested information to the user; and
logging the request, requested information, and other communication variables in a database.

4. The method of claim 3 wherein the method is performed using one or more processors.

5. The method of claim 3 wherein the method is performed using one or more computing devices.

6. The method of claim 3 wherein the requested information comprises one or more of business hours, business contact information, business services, business goods, business promotions and any other conventional business information for suitable purposes.

7. The method of claim 3 wherein the step of receiving at least one request for information from a user further comprises receiving an alphanumeric request corresponding to a stored action step.

8. The method of claim 7 wherein the stored action step further comprises initializing communications about a particular business or plurality of businesses.

9. The method of claim 7 wherein the stored action step further comprises requesting specific information types regarding a particular business or plurality of businesses.

10. The method of claim 3 wherein the other communication variables further comprise one or more of the user's contact information, time stamps for messages and interactions, message statuses, interactive statuses, information regarding user-requested information, and any other conventional information for suitable purposes.

11. In a system comprising a communication management system operating on a processor and configured to receive requests for business information data from a requesting party and communicate said requests to a business information database system, and a business information database system operating on a processor and configured to receive and store business information data, a wherein the communication management system is configured to receive business information data from the business information database system in response to requests for data from the requesting party and also configured to provide real-time business information data to said requesting party, a method comprising:
receiving at least one request for information from a user;
determining the type of requested information based on the request type;
accessing a business information database to retrieve the requested information;
providing the requested information to the user; and
logging the request, requested information, and other communication variables in a database.
